(19) United States
(12) Patent Application Publication
(10) Pub. No.: US 2003/0026186 A1
(43) Pub. Date: Feb. 6, 2003

(54) Information storage medium and information recording method

(76) Inventors: Hideo Ando, Hino-shi (JP); Hideki Takahashi, Kashiwa-shi (JP); Hideki Mimura, Yokohama-shi (JP)

Correspondence Address: PILLSBURY WINTHROP, LLP, P.O. BOX 10500, MCLEAN, VA, 22102, US

(21) Appl. No.: 10/210,880

(22) Filed: Aug. 2, 2002

(30) Foreign Application Priority Data
Aug. 3, 2001 (JP) 2001-236731
Nov. 7, 2001 (JP) 2001-342145

(51) Int. Cl. G11B 7/00

(52) U.S. Cl. 369/53.24; 369/59.25

(57) ABSTRACT

An information storage medium has a logical space managed by a first file system, and the logical space has a space for storing a file used to designate a space area of a second file system, which is different from the first file system.

### CROSS-REFERENCE TO RELATED APPLICATIONS

This application is based upon and claims the benefit of priority from the prior Japanese Patent Applications No. 2001-236731, filed Aug. 3, 2001; and No. 2001-342145, filed Nov. 7, 2001, the entire contents of both of which are incorporated herein by reference.

### BACKGROUND OF THE INVENTION

1. Field of the Invention

The present invention relates to an information storage medium having a logical space managed by a predetermined file system. The present invention also relates to an information recording method for recording information on an information storage medium having a logical space managed by a predetermined file system.

2. Description of the Related Art

As a file system that is compatible with an information recording medium (optical disk or disc), the UDF (Universal Disk Format) standard is known. Details of the UDF standard are described in “Universal Disk Specification Revision 2.00 Apr. 3, 1998 Optical Storage Technology Association”.

Currently, all file systems associated with DVDs (Digital Versatile Disks) adopt this UDF standard.

The UDF standard suffers the following problems (1) to (3).

(1) Since the file system structure specified by the UDF is complicated, tangled processes are required. To solve this problem, if a file system having a simple structure specifically designed for the CE (Consumer Electronics) market is adopted, the recording/playback process of an information recording/playback apparatus or information playback apparatus can be greatly simplified, and a system (information recording/playback apparatus or information playback apparatus) that can hardly produce software errors (bugs) can be provided.

(2) However, a unique file system specifically designed for the CE market cannot process conventional DVD files. Conventional DVD applications adopt the UDF upon recording AV files on optical disks. For this reason, such unique file system specifically designed for the CE market cannot process existing DVD application files.

(3) The DVD standard assumes a mixed environment of PC/AV files, and it is desired to provide an environment that can integrally handle not only files defined by the DVD application standard but also files of wordprocessing software, spreadsheet software, and the like on a single disk. It is not easy for a file system dedicated to AV files to handle PC files.

It is an object of the present invention to solve the aforementioned problems, and to provide an information storage medium and information recording method that can utilize the advantages of a plurality of file systems.

### BRIEF SUMMARY OF THE INVENTION

In order to solve the above problems and to achieve the above object, an information storage medium and information recording method of the present invention have the following arrangements.

(1) An information storage medium according to an embodiment of the present invention comprises a logical space managed by a first file system, and the logical space has a space that stores a file used to designate a space area of a second file system, which is different from the first file system.

(2) An information recording method according to an embodiment of the present invention is directed to an information recording method for recording information on an information storage medium having a logical space managed by a first file system, comprising the step of recording in the logical space a file used to designate a space area of a second file system, which is different from the first file system.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing a coexistence method of a file system specifically designed for the CE environment and a UDF used in DVD;

FIG. 2 is a table that compares allocation setting methods of various files on a UDF logical address space in the coexistence method shown in FIG. 1;

FIG. 3 is a view showing an example of the allocation setting method of a DVD object file on the UDF logical address space in the coexistence method shown in FIG. 1;

FIG. 4 is a view showing an example of the allocation setting method of a file indicating a file system space specifically designed for the CE environment on the UDF logical address space in the coexistence method shown in FIG. 1;

FIG. 5 is a view for explaining various files and dummy files in the coexistence method shown in FIG. 1;

FIG. 6 is a view for explaining expansion (reduction) of the file size of CE_FILE_AREA.CEF;

FIG. 7 is a flow chart showing the conventional volume & file structure read sequence by the UDF;

FIG. 8 is a flow chart showing the volume & file structure read sequence upon adopting the coexistence method shown in FIG. 1;

FIG. 9 is a view for explaining assignment and a WRITE/READ process method of CE_FILE_AREA.CEF;

FIG. 10 is a table showing an example of the data structure of a trigger file;

FIG. 11 is a flow chart showing a process for confirming the CE file location by the trigger file;

FIG. 12 is a flow chart showing the process when the head sector of the trigger file cannot be read out;

FIG. 13 is a flow chart showing a process for adding or deleting a CE file by utilizing the trigger file;

FIG. 14 is a schematic diagram showing the arrangement of a system that implements the coexistence method shown in FIG. 1;

FIG. 15 shows a coexistence method different from that shown in FIG. 1;

FIG. 16 is a view showing file allocation indicating a UDF logical address space on a file system space specifically designed for the CE environment in the coexistence method shown in FIG. 15;

FIG. 17 is a flow chart showing the recording process to CE_FILE_AREA.CEF managed by the trigger file;

FIG. 18 is a flow chart showing the add process of CE_FILE_AREA.CEF managed by the trigger file;

FIG. 19 is a flow chart showing the size reduction process of CE_FILE_AREA.CEF managed by the trigger file;

FIG. 20 is an explanatory view showing the concept of the basic relationship between the hierarchized file system structure and the information contents recorded on an information storage medium;

FIG. 21 is an explanatory view of the description contents of a long allocation descriptor (large-size descriptor indicating the extent location);

FIG. 22 is an explanatory view of the description contents of a short allocation descriptor (small-size descriptor indicating the extent location);

FIG. 23 is an explanatory view of the description contents of an unallocated space entry (special registration descriptor that pertains to the location of an unrecorded extent on the information storage medium);

FIG. 24 is a content explanatory view selectively showing the description contents of a file entry (descriptor that pertains to information registration of a file attribute and file recorded location);

FIG. 25 is a content explanatory view selectively showing the description contents of a file identifier descriptor (descriptor that pertains to the name of a file and the recorded location of a corresponding FE);

FIG. 26 shows an example of the file system structure;

FIG. 27 is a partial view (part 1) showing a recording example of a file system on an information storage medium according to the UDF;

FIG. 28 is a partial view (part 2) showing a recording example of a file system on an information storage medium according to the UDF; and

FIG. 29 is a partial view (part 3) showing a recording example of a file system on an information storage medium according to the UDF.

### DETAILED DESCRIPTION OF THE INVENTION

Points of the present invention will be cited first.

(1) Two different file systems, i.e., a UDF and a unique file system specifically designed for the CE market, are coexistently recorded on a single information storage medium. That is, a file system having a simple structure specifically designed for the CE market is allowed to be adopted on a single information storage medium and, at the same time, existing DVD application files and PC files are allowed to be handled on that information storage medium.

(2) One of the two different file systems manages the logical space on the information storage medium, and a file for designating the other file system space area is defined on that logical space.

(3) The load on CE is reduced by imposing strong limitations associated with AV specific file allocation.

(4) A mechanism that allows file manipulation on the UDF without any file system drivers of the UDF is obtained.

A preferred embodiment of the present invention will be described hereinafter with reference to the accompanying drawings.

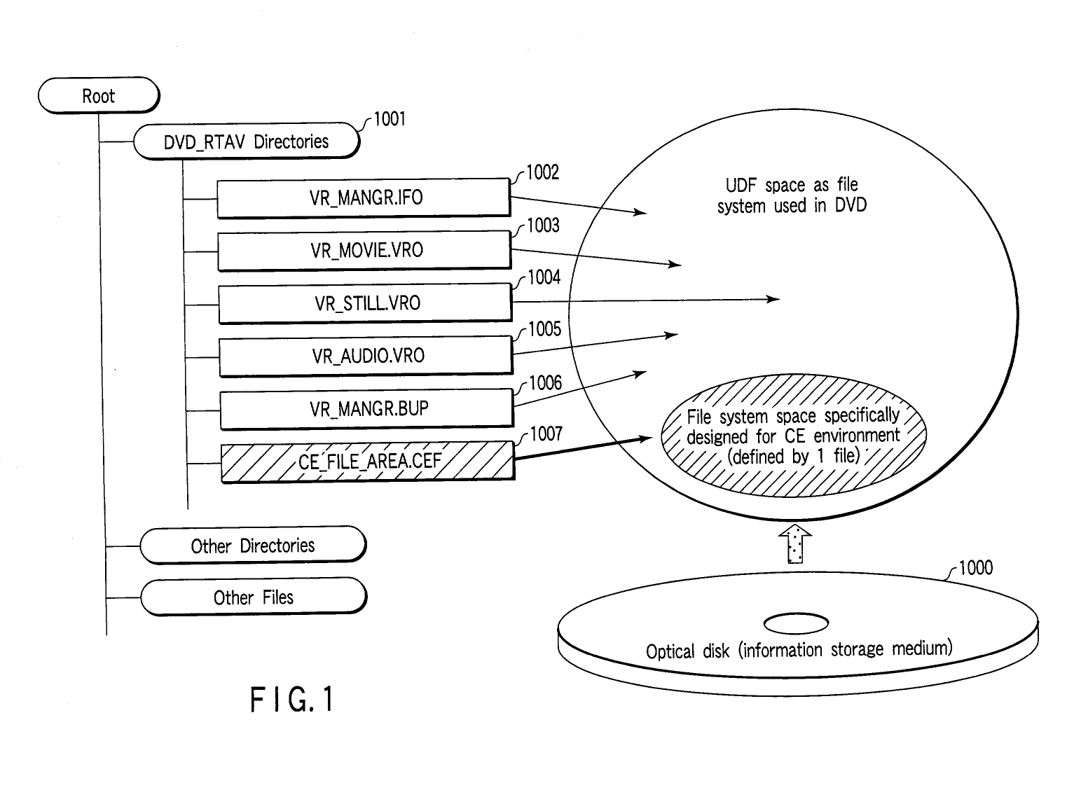

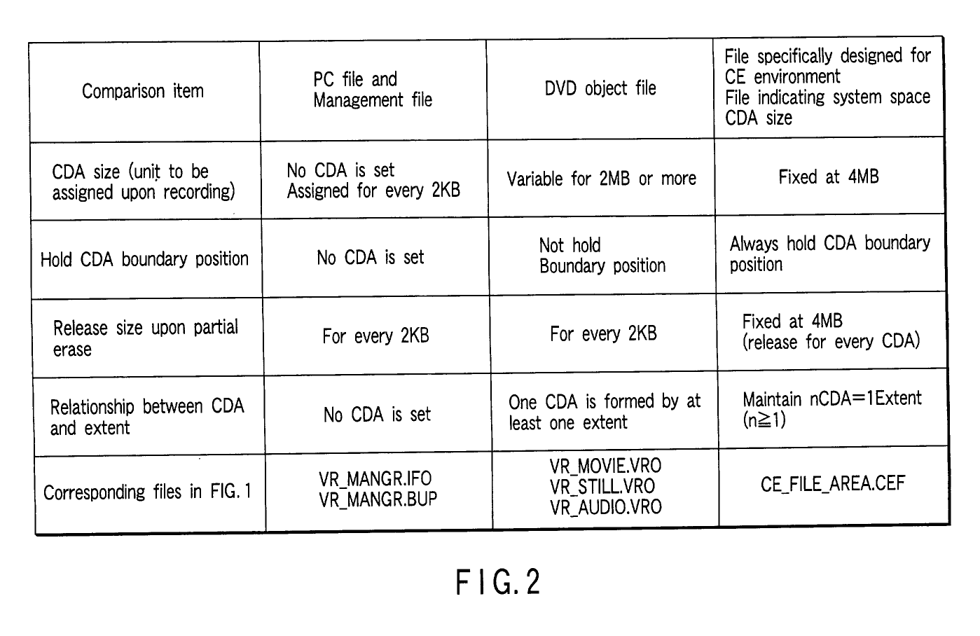

FIG. 1 shows the coexistence method between a file system specifically designed for the CE environment, and the UDF used in DVD. DVD files on an optical disk (information storage medium) 1000 are stored in a directory specially assigned on the UDF. FIG. 1 shows a state wherein a plurality of files are stored in DVD_RTAV Directories 1001 defined to store recording system application files.

In this embodiment, a newly defined file CE_FILE_AREA.CEF 1007 is stored in addition to a conventional Video recording file group (VR_MANGR.IFO 1002, VR_MOVIE.VRO 1003, VR_STILL.VRO 1004, VR_AUDIO.VRO 1005, VR_MANGR.BUP 1006). The conventional Video recording file group is directly managed by the UDF. By contrast, CE_FILE_AREA.CEF is characterized in that an area occupied by that file is defined on the UDF, but the file includes a file system space specifically designed for the CE environment different from the UDF. CE_FILE_AREA.CEF is a file, but has a function like one partition. That is, this file does not change in accordance with the contents size, but is merely assured as an area. Only when the area is assured, the file must be registered on the UDF. Once the file is registered on the UDF, the file size and occupied address locations remain unchanged even when information in that file is rewritten. That is, that file becomes an invariable area on the UDF. If the file size is to be changed, a special process is required, as will be described later.

FIG. 2 compares allocation setting methods of various files on the UDF logical address space in the method shown in FIG. 1. PC files and management files of DVD applications are assigned for respective sectors in terms of file allocation. The sector size in this example is 2 kB. Continuity of each DVD object file (image file) may be disturbed if the minimum size of a CDA (Contiguous Data Area) as a continuous area that includes a discontinuous portion is 2 MB, and the CDA includes defective sectors and the like. For this reason, the CDA size is adjusted to prevent buffer underrun upon playback. For example, in case of a DVD-RAM, a defective sector, zone boundary, or another file may be inserted at a location where continuity is disturbed. In order to calculate the CDA size, the number and distribution of such discontinuous points (number of sectors) must be taken into consideration. If no new defect is found upon recording, since a host can acquire information associated with the recording location in advance, the CDA size can be calculated. However, if a new defect found upon recording is to be skipped, a re-calculation is required to obtain a minimum required CDA size when such defect is found. Such real-time processing method is not particularly limited as long as the recorded result does not cause any buffer underrun upon playback, although it depends on the way a set is formed.

The DVD object file requires allocation which assures seamless playback upon recording, but seamless is not used as a condition when the file is edited after recording. For example, when recorded data is partially deleted, it can be processed for every 2 kB (sectors). As for the relationship between a CDA and an extent (a file portion, and one file is formed by coupling at least one extent) on the UDF, one CDA is formed by at least one extent. Since an extent must be continuous by definition, if a discontinuous portion is included, the extent must be divided at that position. In case of the DVD object file, the CDA boundary position can move everywhere.

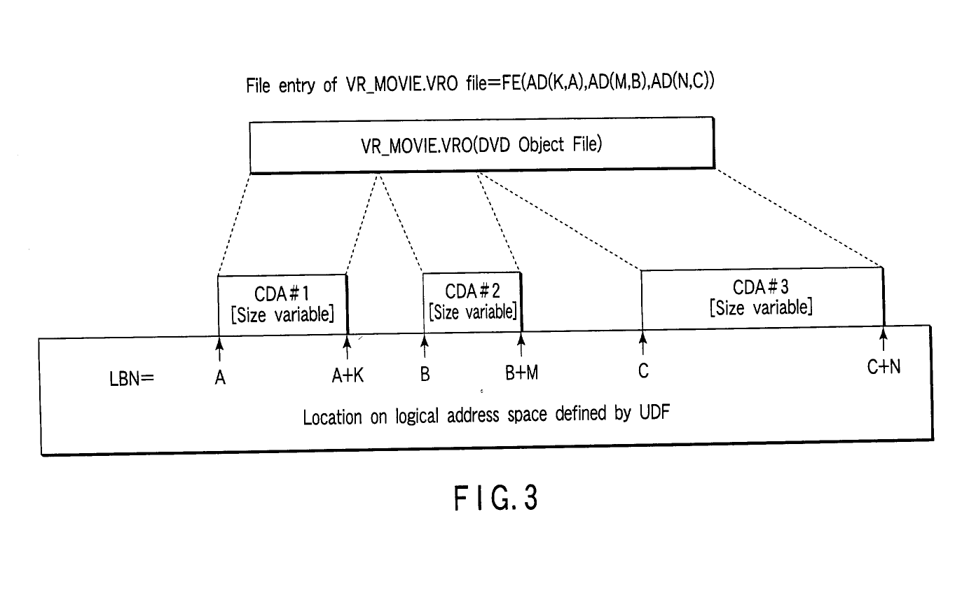

FIG. 3 shows an example of the allocation setting method of a DVD object file on the UDF logical address space in the method shown in FIG. 1. The CDA (or extent) size (K, M, N) that designates the location of a DVD object file is set to be an arbitrary value as an integer multiple of 2 kB as long as K≧2 MB, M≧2 MB, and N≧2 MB hold. The CDA size need not always match the extent size, and one CDA is formed by at least one extent. Addition/release in a file for every 2 kB can be made. For example, when data (size N1) contained in CDA#3 is partially deleted, CDA#3 may be segmented into CDA#3a and CDA#3b. Note that size N1 of deleted data+size N2 of CDA#3a+size N3 of CDA#3b=N, and N2≧2 MB, N3≧2 MB hold.

By contrast, in a file that represents the file system space specifically designed for the CE environment, a CDA as a basic unit of a DVD object file is handled as a fixed size (4 MB or more). If too small a CDA size is set, since buffer underrun occurs upon playback, the CDA size is, e.g., 4 MB. A larger size may be assigned. However, if the basic unit size is too large, use efficiency of the disk impairs in turn. Since no PC file enters the CE specialized file system, a fixed-size area can be set in advance. For example, if the CDA size is 4 MB, CDA boundaries are present for every 4 MB and remain unchanged. In other words, this file size is an integer multiple of 4 MB.

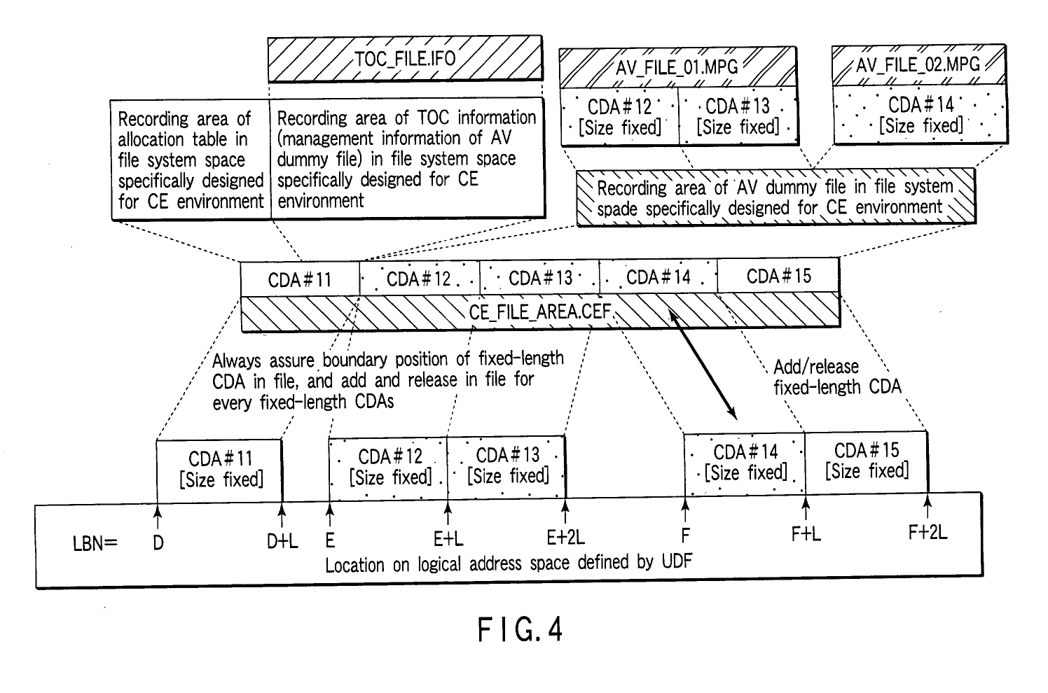

FIG. 4 shows an example of the allocation setting method of a file that represents the file system space specifically designed for the CE environment on the UDF logical address space in the method shown in FIG. 1. A file entry of the CE_FILE_AREA.CEF file=FE(AD(L, D), AD(L, E), AD(L, E+L), AD(L, F), AD(L, F+2L)).

The CDA size is equal to the extent size, and all CDA sizes are constant (4 MB or more). The size of each dummy file (AV_FILE_{—}01.MPG/AV_FILE_{—}02.MPG) in the file system space specifically designed for the CE environment is an integer multiple of the CDA size, and the location on the disk matches that of the CDA. An AV dummy file is added/released for respective fixed-length CDAs.

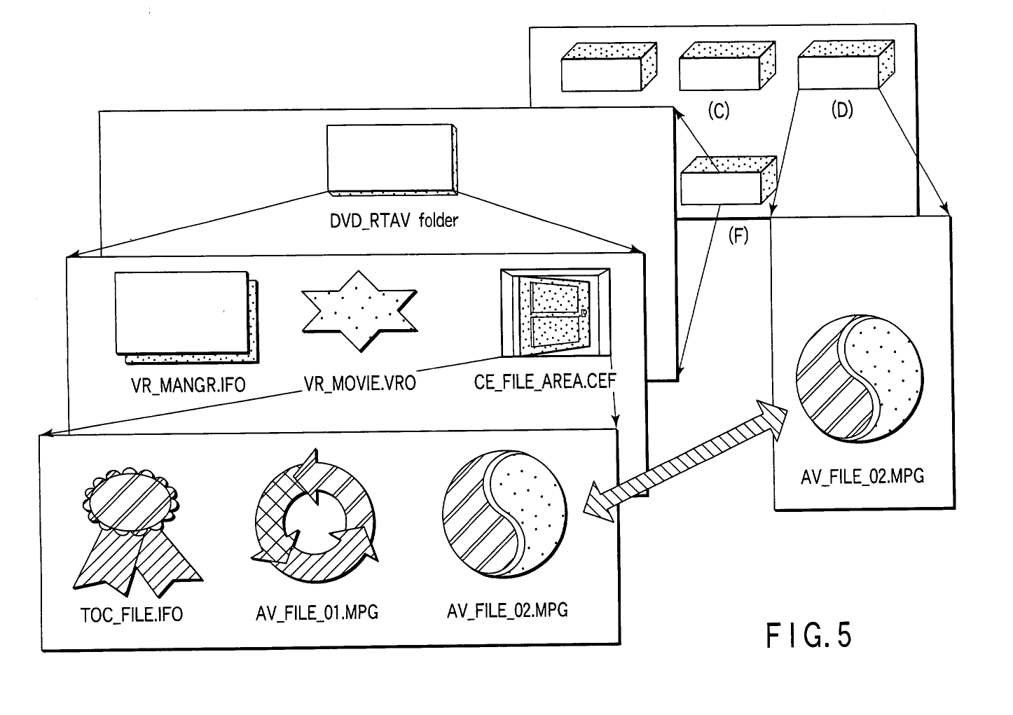

FIG. 5 is an explanatory view of a display example of various files and dummy files in the method shown in FIG. 1. As shown in FIG. 5, CE_FILE_AREA.CEF includes files, and the CE file group in this file must be viewed on a PC via a special file viewer. Since CE_FILE_AREA.CEF includes the file group, each file can be extracted from the UDF to a directly visible area, if necessary. Once a file is extracted from the UDF to a directly visible area, it can be copied or moved by normal file manipulations on the PC. Conversely, such extracted file can be returned to CE_FILE_AREA.CEF. Basically, in order to implement seamless playback, since allocation on the disk must be devised, a file must be fetched into CE_FILE_AREA.CEF via a special allocation tool.

Comparison between merits of the file system specifically designed for the CE environment and the UDF, and significance of coexistence of them on a single storage medium will be summarized below.

Merits obtained upon adopting the file system specifically designed for the CE environment are as follows.

(1) The use purpose is specialized to AV information recording to obtain an optimal, simple file system, thus making control software compact. PC files are inhibited from being recorded together in this file system, thus simplifying control software.

(2) Compact file system components specifically designed for the CE environment are formed, thus allowing consolidated use in an upper layer. Also, coexistence with PC files in the upper layer is allowed.

Merits obtained upon adopting the UDF as a file system are as follows.

(1) AV information generated based on the existing DVD standard can be recorded.

(2) PC files can be recorded together.

(3) Control units associated with file systems of already commercially available DVD related products can be effectively used.

When these file systems coexist on a single storage medium, their merits can be utilized.

Limitations to be imposed upon allocating CE_FILE_AREA.CEF are as follows.

(1) Inhibit Relocation

For example, if a defrag process or the like is done on the file system level, allocation changes. Hence, special management on the UDF (e.g., assignment of a new number dedicated to file type 249 or DVD, setting of a non-relocatable attribute, or the like) is required. If relocation in the UDF is inhibited, the assigned area remains unchanged, and a file can have area information such as LSN (Logical Address Number) or the like assigned as a file and can execute a process in it.

(2) Fix Start Address of File

If the start address of a file can be fixed, CE can execute a recording/playback process without interpreting the UDF.

(3) Independently Define and Allocate File Indicating Configuration of CE_FILE_AREA.CEF

All pieces of location information of all extents are stored together in a single file.

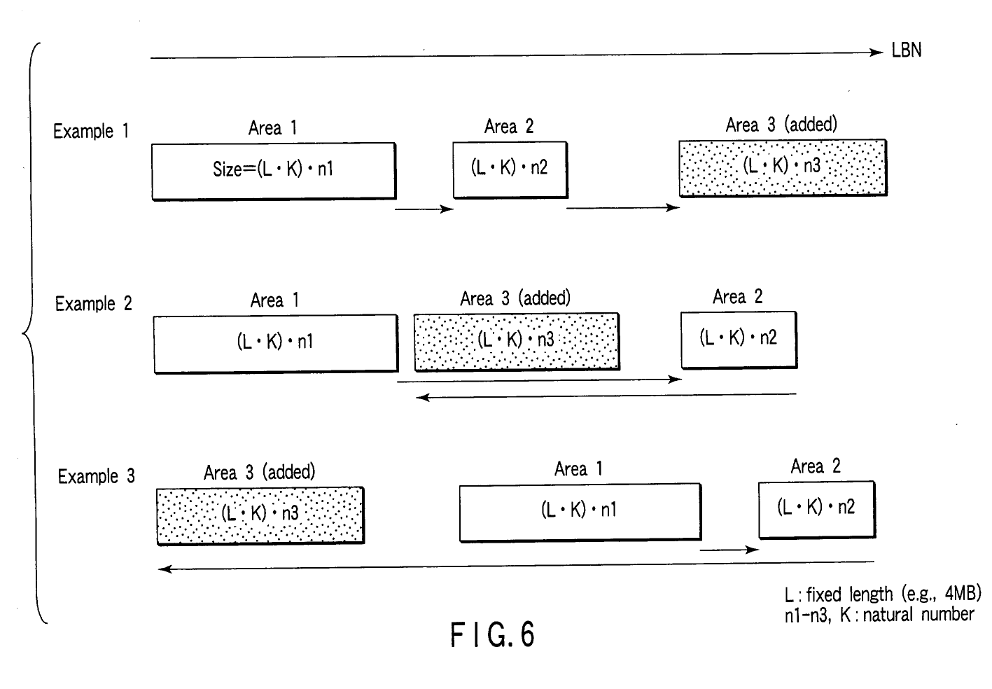

FIG. 6 shows an example of expansion (reduction) of the file size of CE_FILE_AREA.CEF. A file is formed by at least one area, and the size of each area can be varied using an integer multiple of a fixed length L as a unit.

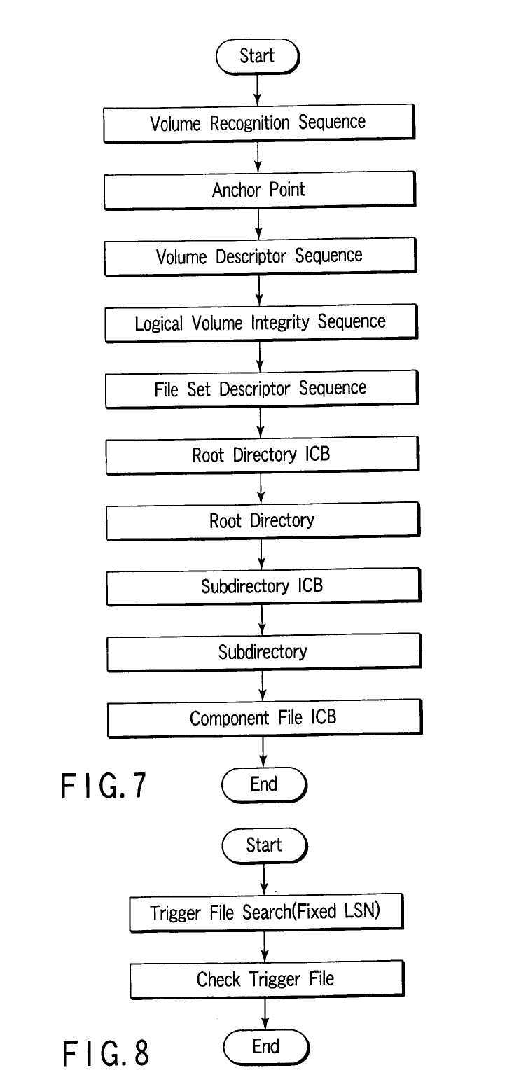

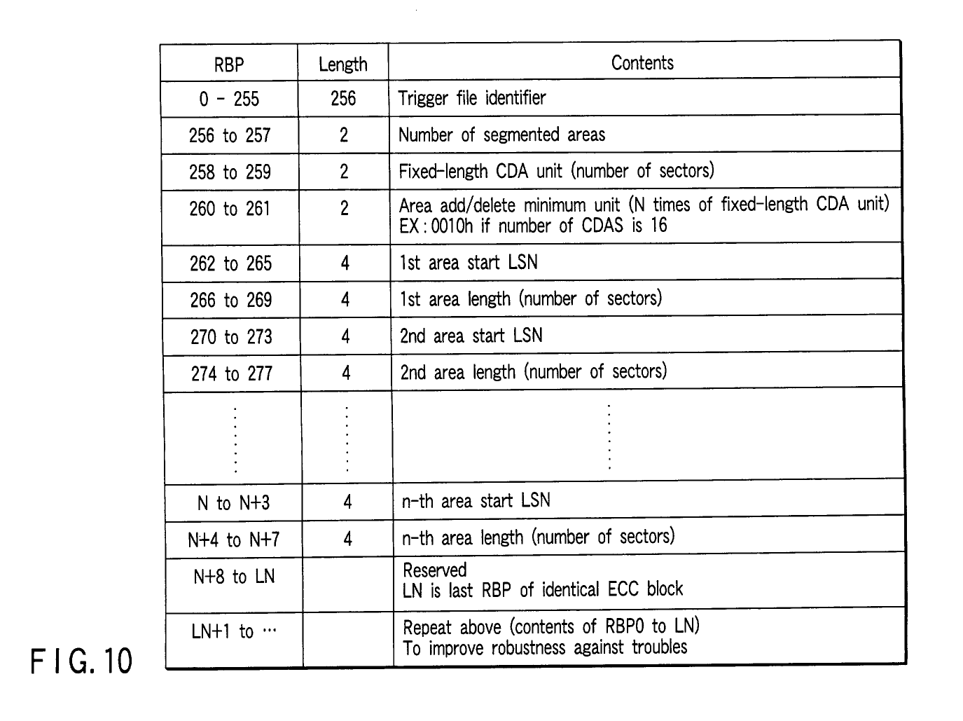

FIG. 7 shows the conventional volume & file structure read sequence by the UDF. Contrary to this, when CE_FILE_AREA.CEF is appropriately set, volume & file structure information can be read out by greatly reducing interpretation steps of the UDF, as shown in FIG. 8. This embodiment exemplifies a case wherein a trigger file allocated at a fixed LSN is defined, and is searched to obviate the need for interpreting the UDF. The trigger file indicates the location information CE_FILE_AREA.CEF, as shown in FIG. 10.

By defining the trigger file, an apparatus can specify the location of a file without interpreting the UDF. Interpretation of the trigger file is required, but is much easier than that of the UDF.

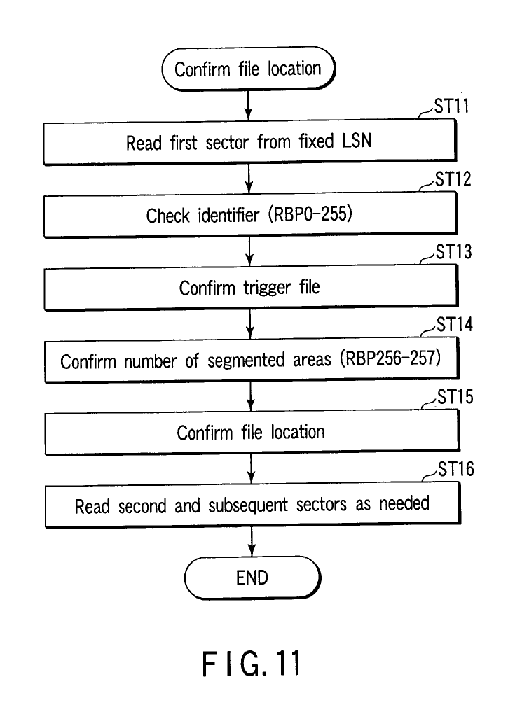

FIGS. 11 to 13 show utilization examples of the trigger file. For example, if an identifier (256 bytes) which is defined to confirm if a file of interest is a trigger file is available, the probability of generation of identification errors is sufficiently small. The number of bytes of the identifier may be reduced as needed. Since the trigger file is allocated at a fixed LSN, which is determined in advance, M sectors from the LSN are assured as a trigger file area, and if the contents of the trigger file are allocated in different ECC blocks a plurality of number of times, information can be extracted even when the head of a file cannot be read out due to any failure.

As shown in FIG. 11, the location of the trigger file is confirmed. The first sector is read from the fixed LSN (ST11), and an identifier (RBP0 to RBP255) are checked (ST12). If the trigger file is confirmed (ST13), the number of segmented areas (RBP256 and RBP257) is confirmed (ST14) to confirm the location of the file (ST15). The second and subsequent sectors are read as needed (ST16).

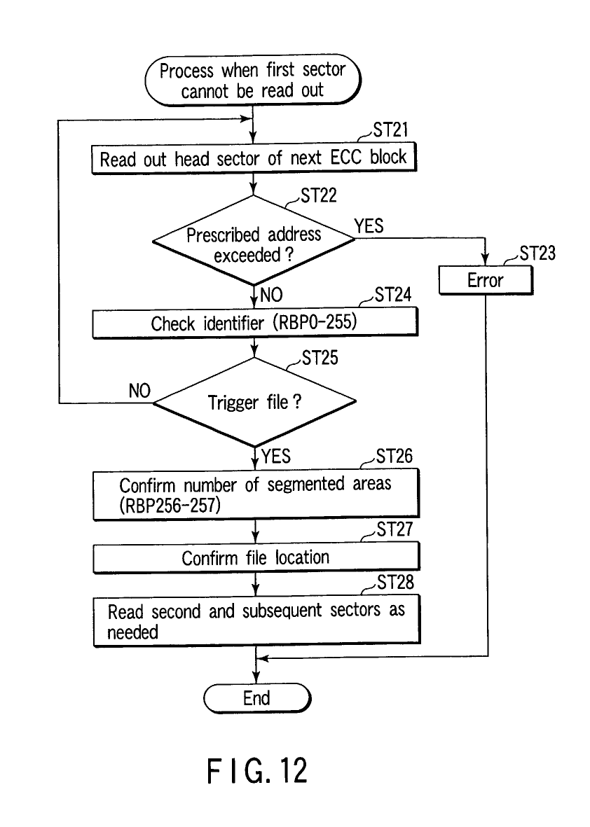

A case will be explained below with reference to FIG. 12 wherein the first sector cannot be read out. When the first sector cannot be read out, the head sector of the next ECC (Error Correction Code) block is read out (ST21). If a prescribed address is exceeded (ST22, YES), an error is determined (ST23). If the prescribed address is not exceeded (ST22, NO), the identifier (RBP0 to RBP255) is checked (ST24). If a trigger file is confirmed (ST25, YES), the number of segmented areas (RBP256 and RBP257) is confirmed (ST26) to confirm the location of the file (ST27). The second and subsequent sectors are read as needed (ST28).

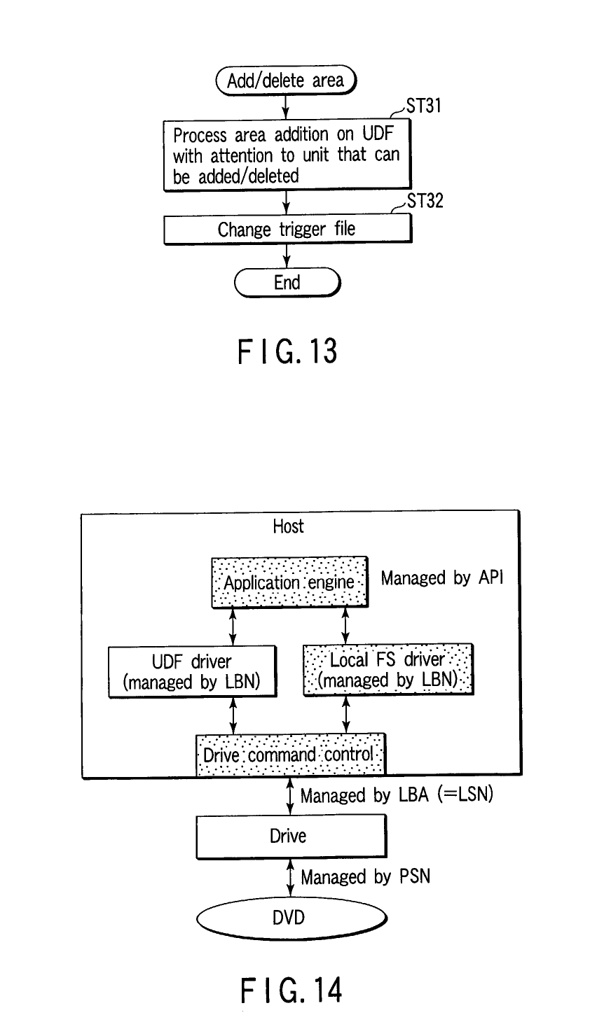

A process executed when an area is to be added/deleted will be explained below with reference to FIG. 13. Area addition/deletion is processed on the UDF with attention to a unit that can be added/deleted (ST31), and the trigger file is changed accordingly (ST32).

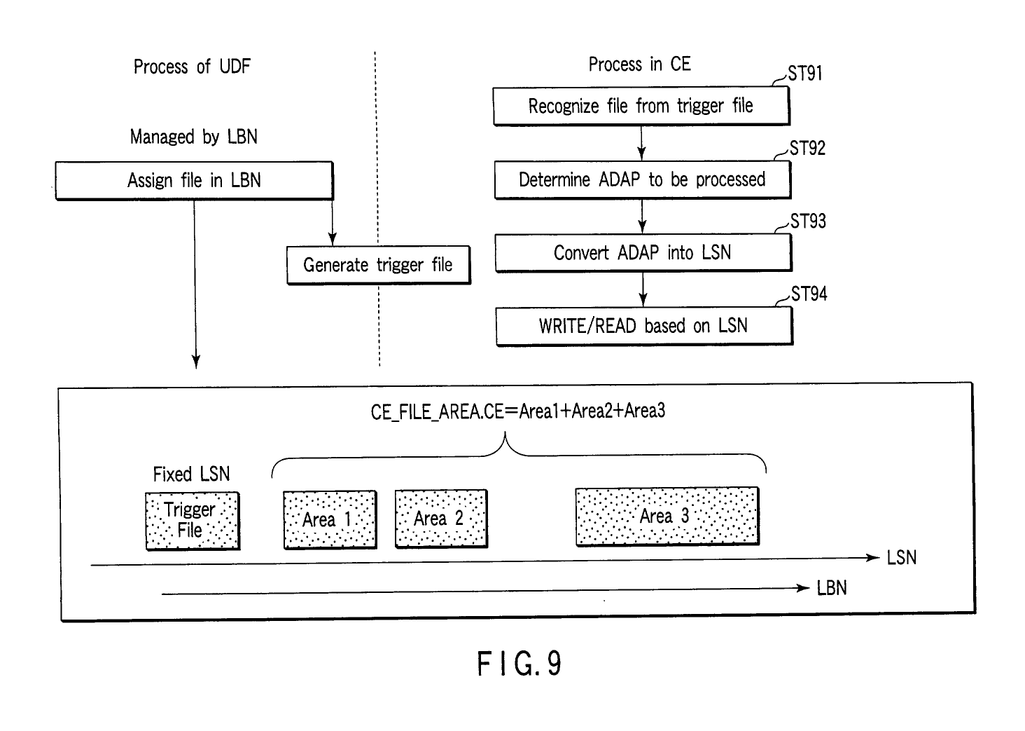

FIG. 9 shows assignment and a WRITE/READ process method of CE_FILE_AREA.CEF. CE_FILE_AREA.CEF is initially assigned in LBN (Logical Block Number) by the UDF. After assignment, the location information of the file is recorded in the trigger file. In this example, the trigger file is also allocated in the UDF, and the location of the trigger file is specified by predetermined M sectors starting from the fixed LSN, which is determined in advance. Once the trigger file is generated in this way, a CE apparatus recognizes CE_FILE_AREA.CEF from the trigger file without interpreting the UDF (ST91) to determine an address used in an application (ADAP: Address in application) (ST92), converts that ADAP into LSN (ST93), and can execute WRITE/READ using the converted LSN (ST94).

In order to increase the degree of freedom, the trigger file is separated from CE_FILE_AREA.CEF as a file entity. However, contents recorded in the trigger file may be present in (e.g., at the head of) CE_FILE_AREA.CEF. In this case, if the head LSN of CE FILE AREA.CEF is fixed, it is advantageous for a CE apparatus.

FIG. 14 shows an example in which the aforementioned mechanism is configured as a system. A host has a Local FS driver for handling CE_FILE_AREA.CEF, and can control a drive via a drive command control unit. For example, if the entire area of the disk is assigned as CE_FILE_AREA.CEF, simple system control can be made without any UDF management.

By assigning CE_FILE AREA.CEF to the entire DVD_RTAV directories 1001, the need for changing the UDF can be obviated.

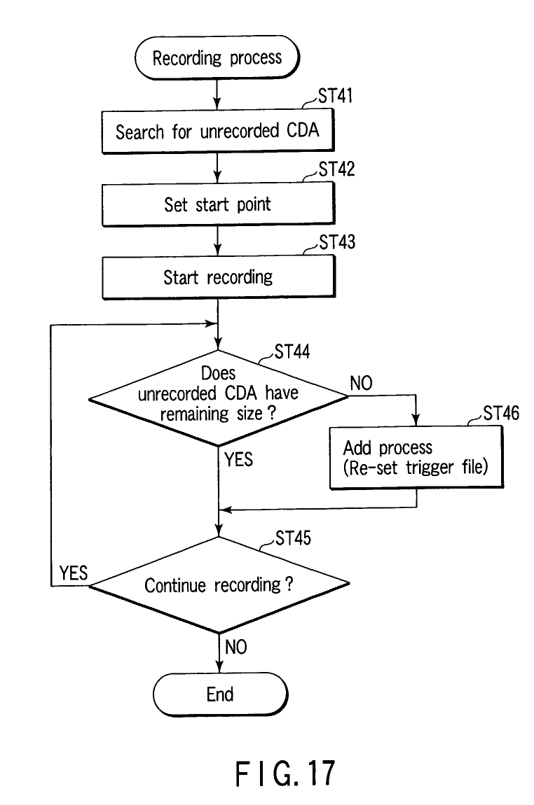

Recording on the CE_FILE_AREA.CEF space, addition of the CE_FILE_AREA.CEF space, reduction of the CE_FILE_AREA.CEF space, and the like will be explained below with reference to the flow charts in FIGS. 17 to 19.

A recording process on the CE_FILE_AREA.CEF space will be summarized first with reference to the flow chart shown in FIG. 17. An unrecorded CDA is searched with reference to the trigger file (ST41), and a start point is set in the unrecorded CDA (ST42), thus starting recording (ST43). If the remaining size of the unrecorded CDA becomes smaller than a predetermined size (ST44, NO), an addition process (trigger file re-set) is executed (ST46). While recording continues (ST45, YES), the processes in steps ST44 to ST46 are repeated.

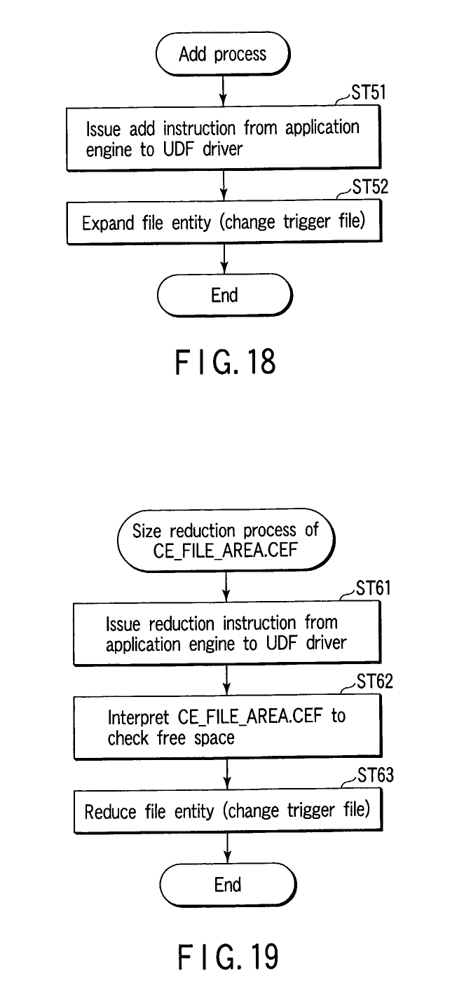

The addition process of the unrecorded CDA will be summarized below with reference to the flow chart shown in FIG. 18. An application engine issues an add instruction to a UDF driver (ST51). In response to this instruction, the entity of a file is expanded (ST52). That is, the trigger file is changed.

A size reduction process of CE_FILE_AREA.CEF will be described below with reference to the flow chart shown in FIG. 19. The size reduction process of CE_FILE_AREA.CEF is executed when data on the UDF is full. The application engine issues a reduction instruction to the UDF driver (ST61). In response to this instruction, CE_FILE_AREA.CEF is interpreted to check a free space (ST62), and the file entity is reduced (ST63). That is, the trigger file is changed.

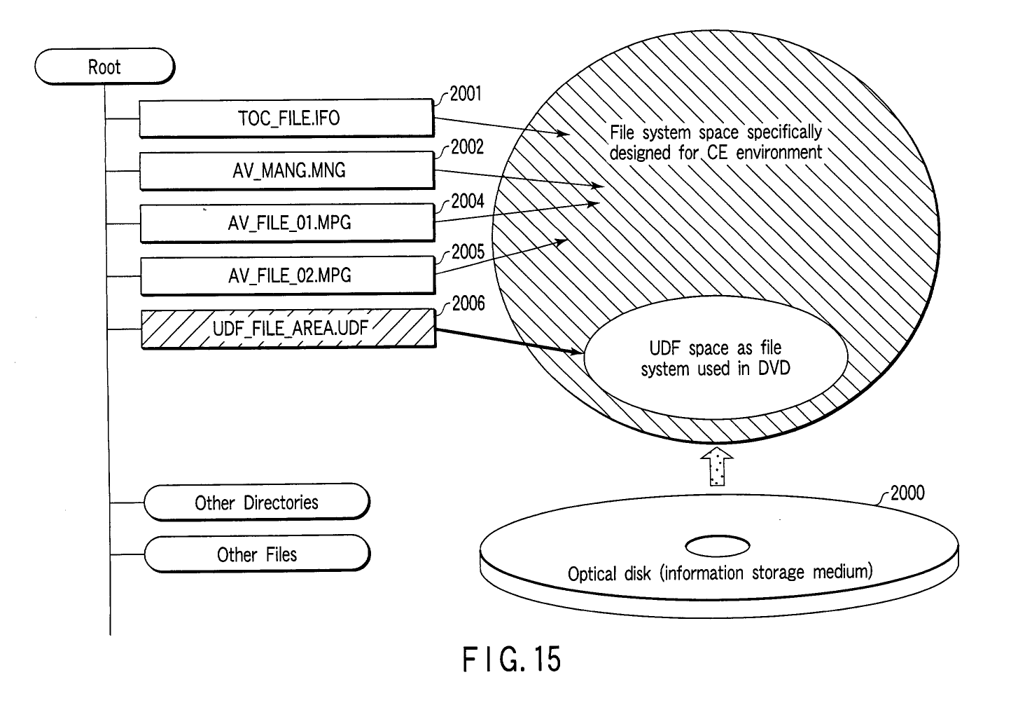

Another embodiment of the present invention different from FIG. 1 will be explained using FIG. 15. In FIG. 1, the UDF space is used as a base, and the file system space specifically designed for the CE environment is built in the UDF space by file definition. By contrast, in FIG. 15, the entire logical space on an optical disk (information storage medium) 2000 is assigned to a “file system space specifically designed for the CE environment”, which is used as a base. For example, a file named “UDF_FILE_AREA.UDF” is defined in the “file system space specifically designed for the CE environment”, and a “UDF space” as a file system used in DVD is assigned as the location of that file.

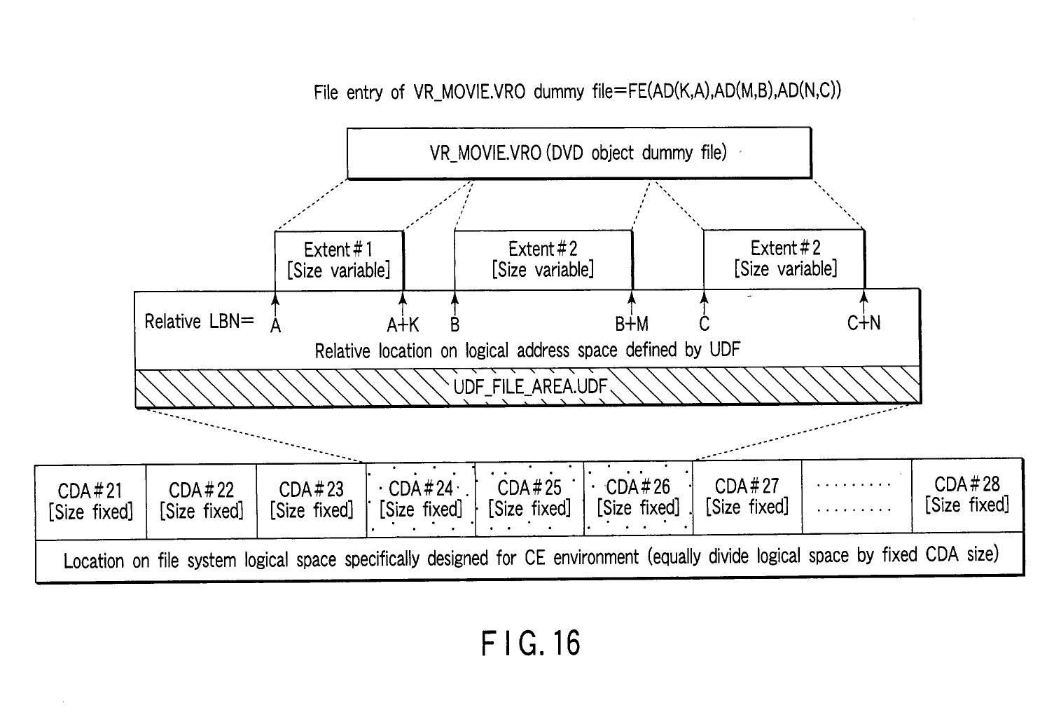

FIG. 16 shows the recording method of respective files in the method shown in FIG. 15. When the method shown in FIG. 15 is adopted, the entire logical address space on the optical disk (information storage medium) is equally segmented into CDAs with a fixed size (e.g., 4 MB or more), and the location of each recorded file is assigned with reference to the CDA position. That is, the location and size of “UDF FILE_AREA.UDF 2006” as a file used to assign the UDF space are defined by assigning one or a plurality of CDAs each having a fixed size.

In an embodiment shown in FIG. 16, the locations of CDA#24 to CDA#26 are assigned to the above file. That is, the range of CDA#24 to CDA#26 is established as the UDF space. The range of CDA#24 to CDA#26 is further segmented for every 2 kB, and relative LBNs (Logical Block Numbers) as addresses in the UDF space are assigned. A DVD object file (e.g., “VR_MOVIE.VRO” file) can be allocated within this UDF space. As shown in FIG. 2, a CDA for the DVD object file is assigned to have a variable size of 2 MB or more (which can be changed for every 2 kB), and an extent indicated by an allocation descriptor in a file entry of this file is described using the relative LBN (Logical Block Number).

A general file location on the file system space specifically designed for the CE environment is also set with reference to CDAs each having a fixed size. “AV_FILE_{—}01.MPG 2004” and “AV_FILE_{—}02.MPG 2005” in FIG. 15 mean AV files (object files associated with video or audio information), and “TOC_FILE.IFO 2001” and “AV_MANG.MNG 2002” are management files that record management information associated with these object files. “AV_MANG.MNG 2002” is a file that records attribute information for “AV_FILE_{—}01.MPG 2004” and “AV_FILE_{—}02.MPG 2005” as the object files, and information associated with the overall TOC (Table of Contents: indicating the playback sequence among objects) is recorded in “TOC_FILE.IFO 2001”.

The arrangement and operation effects of the present invention will be summarized below.

(1) An information storage medium of the present invention has a logical space managed by a predetermined file system, the logical space is managed by one of two different file systems, and this logical space has a file for designating a space area of the other file system.

(2) An information recording method of the present invention manages, for an information storage medium having a logical space managed by a predetermined file system, the logical space using one of two different file systems, and records a file for designating a space area of the other file system on the logical space.

With the above arrangement, the following operation effects are obtained.

(1) Write Once, Read Many (Including Movement of Boundary Position) Process

The two different file system areas are set in advance. By repeating addition of files, one area is narrowed down, and the boundary position between the two different file system areas must be moved. In the present invention, the file system that manages the logical space on the information storage medium changes the size of the file for designating the other file system space area, thus easily moving the boundary position. That is, the write once, read many (including movement of the boundary position) process can be done very easily.

(2) Recording/Playback Between AV File on Existing DVD Application Standard and Application File Formed on Unique File System Specifically Designed for CE Market

Since the two different file system areas are completely separated, and the recording/playback process on one file system does not basically influence the other file system, recording/playback between these files can be done very easily.

(3) PC Application File

It becomes easy to record a PC application file on the logical space defined by the UDF, as has been implemented on an information storage medium (optical disk) complying with the existing DVD standard.

(4) Existing Writing Software

Since an existing DVD player or recorder is built up to be able to execute processes on the UDF, data can be recorded on the UDF area using existing writing software.

(5) Existing File System Driver

Since an existing DVD player or recorder is built up to be able to execute processes on the UDF, existing file system drivers can be used for the UDF area.

(6) Allocation Logic

In the present invention, since the file system that manages the logical space on an information storage medium designates the other file system space area in the form of “file location designation”, allocation logic can be simplified.

(7) Simplification of File System Driver

File system drivers can be simplified.

(8) Test

Since an existing DVD player or recorder is built up to be able to execute processes on the UDF, and existing software can be used as test software on the UDF space, tests on the UDF space can be conducted very easily.

(9) Partial Erasure and FS Management

Easy coordination to partial erasure on an application and FS management is assured.

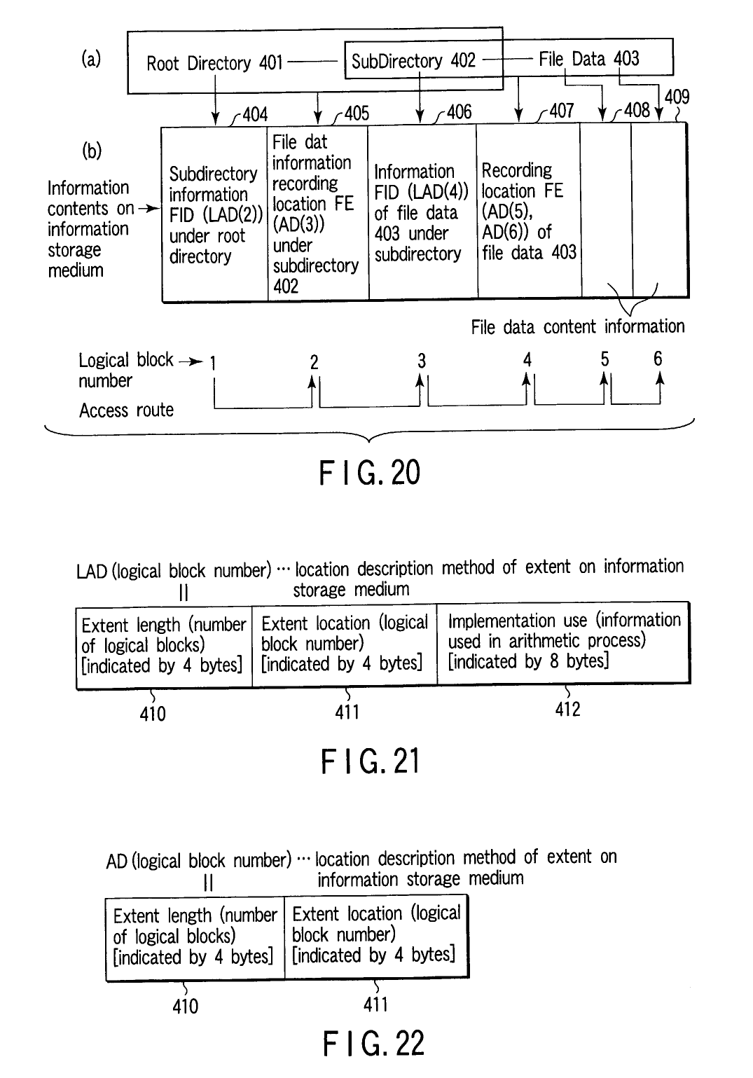

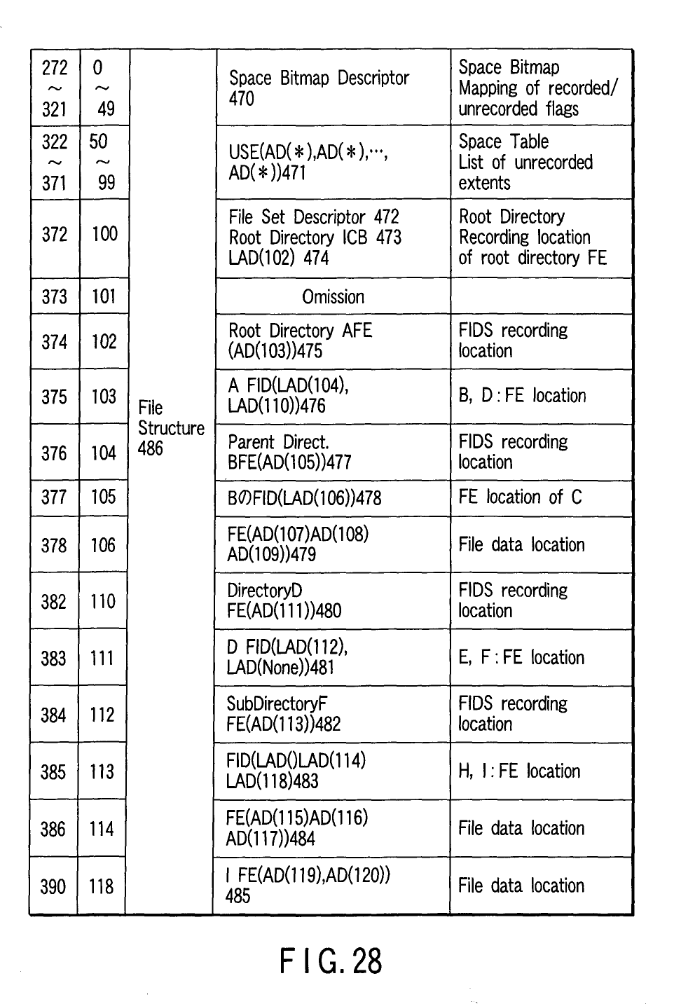

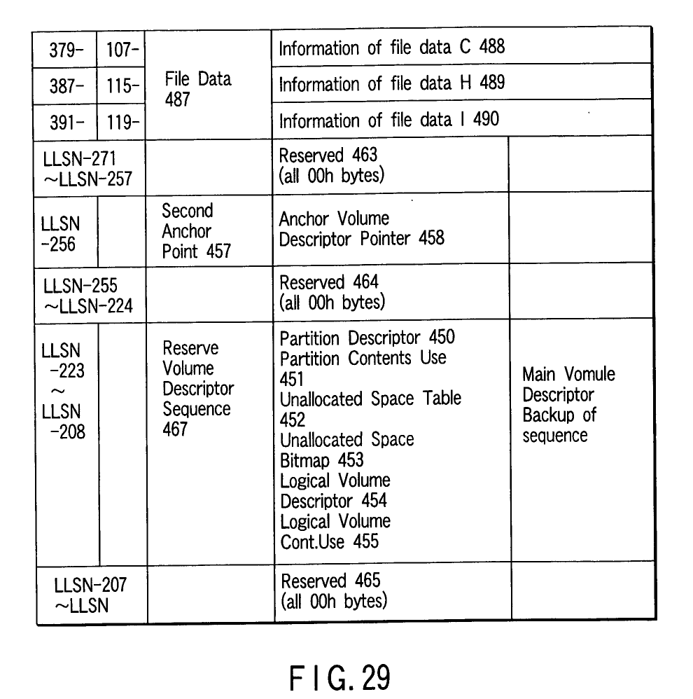

The UDF as one of file systems will be described below using FIGS. 20 to 29.

<<<Outline of UDF (What is UDF)>>>

<<What is UDF>>

The UDF is an abbreviation for Universal Disk Format, and indicates “rules associated with a file management method”. A CD-ROM, CD-R, CD-RW, DVD-Video, DVD-ROM, DVD-R, and DVD-RAM adopt the UDF format standardized by “ISO9660”.

A file management method is based on a hierarchical file system which has a root directory as a parent, and manages files in a tree structure.

The UDF format complying with the DVD-RAM standard (File System Specifications) will be mainly explained below, but most of the contents of the following description match the contents of the DVD-ROM standard.

<<Outline of UDF>>

<File Information Recording Contents on Information Recording Medium>

Upon recording information on an information storage medium, a unit of information is called “file data”, and recording is done in units of file data. A unique file name is appended to each file data to discriminate it from other file data. When a plurality of file data having common information contents are grouped, file management and file search are facilitated. A group of a plurality of file data is called a “directory” or “folder”. A unique directory name (folder name) is appended to each directory (folder). Furthermore, a plurality of directories (folders) are collected and grouped in an upper directory (upper folder) as an upper layer group. In the following description, file data and directories (folders) are generally called as a file.

Upon recording information, all kinds of information associated with

information contents themselves of file data,

file name corresponding to file data, and

saving location of file data (a directory under which file data is to be recorded)

are recorded on an information storage medium.

Also, all kinds of information associated with

directory name (folder name), and

location where each directory (folder) belongs

(location of an upper directory (upper folder) as its parent)

are also recorded on the information storage medium.

<Information Recording Format on Information Storage Medium>

The entire recording area on the information storage medium is segmented into logical sectors each consisting of 2048 bytes as a minimum unit, and serial logical sector numbers are assigned to all the logical sectors. Upon recording information on the information storage medium, information is recorded in units of logical sectors. The recording location on the information storage medium is managed by the logical sector numbers of the logical sectors where the information is recorded.

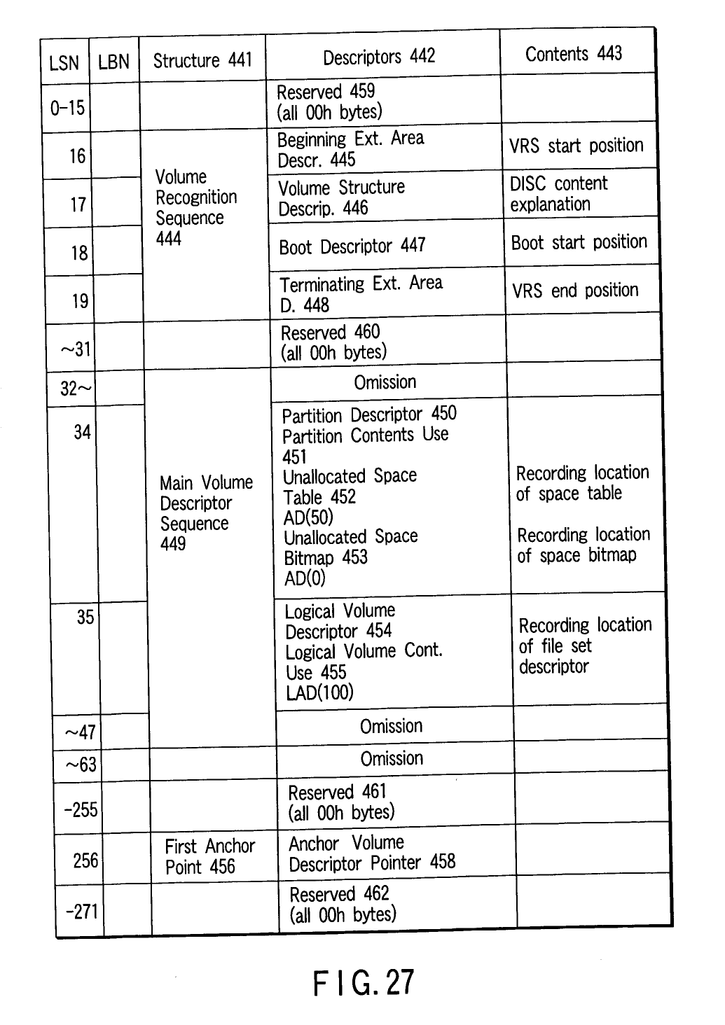

As shown in FIGS. 27 to 29, sectors that record information associated with a file structure 486 and file data 487 are especially called “logical blocks”, and logical block numbers (LBNs) are set in conjunction with the logical sector numbers (LSNs). (The length of each logical block is 2048 bytes as in the logical sector.) Also, LSSN in FIG. 20 indicates the last logical sector number (last LSN).

<Example of Simplified Hierarchical File System>

(a) of FIG. 20 shows an example of a simplified hierarchical file system. In a DVD-RAM, the logical block (logical sector) size is 2048 bytes. A group of continuous logical blocks (logical sectors) is called an “extent”. One extent is formed of one logical block (logical sector) or a chain of continuous logical blocks (logical sectors). In order to access file data recorded on the information storage medium, access to an address (AD(*), LAD(*)) indicated by information is repeated while sequentially reading information, as indicated by an access route shown in FIG. 20.

File management systems of most OSs such as UNIX, MacOS, MS-DOS, Windows, and the like have a tree-like hierarchical structure shown in (a) of FIG. 20.

In each disk drive (each partition if one HDD is partitioned into a plurality of partitions), one root directory 401 as a parent of all directories is present, and a subdirectory 402 belongs to the root directory. File data 403 is present in this subdirectory 402.

A practical structure is not limited to such specific example. For example, file data 403 may be present immediately under the root directory 401, or a complicated hierarchical structure may be formed by a series of a plurality of subdirectories 402.

<Recording Contents of File Management Information on Information Storage Medium>

File management information is recorded in units of logical blocks mentioned above. The contents to be recorded in each logical block are as follows.

Descriptor FID (File Identifier Descriptor) that Indicates Information Associated with File

This descriptor describes the type and file name (root directory name, subdirectory name, file data name, and the like) of file.

The FID also describes the recording location of a descriptor (i.e., FE to be described below corresponding to this file) that indicates the recording locations of the data contents of the subsequent file data, and the contents of the directory.

Descriptor FE (File Entry) that Indicates Recording Location of File Contents

This descriptor describes the locations (logical block numbers) and the like on the information storage medium where information associated with the contents of the directories (subdirectories and the like) are recorded.

FIG. 25 selectively shows the description contents of the file identifier descriptor. A detailed description of this identifier will be given later in the paragraphs of <<File Identifier Descriptor>>. FIG. 24 selectively shows the description contents of the file entry, and a detailed description thereof will be given later in the paragraphs of <<File Entry>>.

As descriptors that indicate the recording locations on the information storage medium, a long allocation descriptor shown in FIG. 21 and a short allocation descriptor shown in FIG. 22 are used. Detailed descriptions of these descriptors will be given later in the paragraphs of <Long Allocation Descriptor>and <Short Allocation Descriptor>.

For example, (b) of FIG. 20 shows the recording contents when information of the file system structure shown in (a) of FIG. 20 is recorded on the information storage medium. The recording contents in (b) of FIG. 20 is as follows.

A logical block with logical block number “1” indicates the contents of the root directory 401.

In the example in (a) of FIG. 20, since the root directory 401 stores the subdirectory 402 alone, information associated with the subdirectory 402 is described using a file identifier descriptor 404 as the contents of the root directory 401. Although not shown, the identical logical block also describes information of the root directory 401 itself using a file identifier descriptor.

The file identifier descriptor 404 of the subdirectory 402 describes the recording location of a file entry 405 (second logical block in the example of (b) in FIG. 20) that indicates the recording location of the contents of the subdirectory 402 using a long allocation descriptor (LAD(2)).

A logical block with logical block number “2” records a file entry 405 indicating the recording location of the contents of the subdirectory 402.

In the example of (a) of FIG. 20, since the subdirectory 402 stores only file data 403, the contents of the subdirectory 402 indicate in practice the recording location of a file identifier descriptor 406, which describes information associated with the file data 403.

A short allocation descriptor in the file entry describes that a third logical block records the contents of the subdirectory 402 (AD(3)).

A logical block with logical block number “3” records the contents of the subdirectory 402.

In the example of (a) of FIG. 20, since the subdirectory 402 stores only the file data 403, information associated with the file data 403 is described using a file identifier descriptor 406 as the contents of the subdirectory 402. Although not shown, the identical logical block also describes information of the subdirectory 402 itself using a file identifier descriptor.

The file identifier descriptor 406 that pertains to the file data 403 describes the recording location of a file entry 407 indicating the recording location of the contents of the file data 403 (recorded in a fourth logical block in the example of (b) of FIG. 20) using a long allocation descriptor (LAD(4)).

A logical block with logical block number “4” records the file entry 407 indicating the recording location of contents 408 and 409 of the file data 403.

Short allocation descriptors in the file entry 407 describe that the contents 408 and 409 of the file data 403 are recorded in the fifth and sixth logical blocks (AD(5), AD(6)).

A logical block with logical block number “5” records the contents information 408 of the file data 403.

A logical block with logical block number “6” records the contents information 409 of the file data 403.

<Access Method to File Data According to Information in (b) of FIG. 20>

As has been briefly explained in “<File system information recording contents on information recording medium>”, the file identifier descriptors 404 and 406 and file entries 405 and 407 describe the logical block numbers that describe the subsequent information.

In the same manner as in a case wherein file data is reached via subdirectories while going down from the root directory to lower layers, the data contents of the file data are accessed while sequentially playing back information in logical blocks on the information storage medium according to the logical block numbers described in the file identifier descriptors and file entries.

That is, in order to access the file data 403 with respect to the information shown in (b) of FIG. 20, the first logical block information is read. Since the file data 403 is present in the subdirectory 402, the information of the first logical block is searched for the file identifier descriptor 404 of the subdirectory 402 to read LAD(2), and the second logical block information is then read according to LAD(2). Since the second logical block describes only one file entry, AD(3) in that file entry is read to access the third logical block. The third logical block is searched for the file identifier descriptor 406 having a description about the file data 403 to read LAD(4). When the fourth logical block is accessed according to LAD(4), since that block describes only one file entry 407, AD(5) and AD(6) are read to find logical block numbers (fifth and sixth) that record the contents of the file data 403.

The contents of AD(*) and LAD(*) will be described in detail later in the paragraphs of “<Detailed contents description of descriptors of UDF>”.

<<Feature of UDF>>

<Description of Feature of UDF>

The feature of the UDF will be explained below upon comparison with the FAT used in an HDD, FDD, MO, or the like.

1) Minimum units (such as a minimum logical block size, minimum logical sector size, and the like) are large, and the UDF is suitable for recording video information and music information with a large information volume to be recorded.

The logical sector (block) size of the UDF is as large as 2048 bytes compared to that (512 bytes) of the FAT.

2) The FAT locally and intensively records an assignment management table (file allocation table) of files on an information storage medium on the information storage medium, while the UDF can distribute and record file management information at arbitrary locations on a disk.

In the UDF, file management information, and the recording locations of file data on the disk are described in allocation descriptors as logical sector (block) numbers.

Since the FAT intensively manages file locations in a file management area (file allocation table), it is suitable for a purpose that frequently requires a change in file structure [mainly for a frequent rewrite purpose]. (The management information can be easily rewritten since it is concentrated and recorded at given location.) Also, since the recording location of the file management information (file allocation table) is determined in advance, a recording medium must have high reliability (suffers less defective areas).

Since the UDF distributes file management information, it is suitable for a purpose of adding a new file structure later under the lowermost layer (mainly to a layer under the root directory) [mainly for a write once, read many purpose]. (This is because previous file management information is rarely changed upon executing the write once, read many process.) Since the recording location of the distributed file management information can be arbitrarily designated, information can be recorded while avoiding inherent defective positions.

Since the file management information can be recorded at an arbitrary location, all pieces of file management information may be collected and recorded at a given location to obtain the merit of the FAT. Hence, the UDF can be considered as a file system with higher versatility.

<<<Detailed Contents Description of Descriptors of UDF>>>

<<Descriptor of Logical Block Number>>

<Allocation Descriptor>

As has been described in “<File system information recording contents on information storage medium>”, a descriptor which is included in a file identifier descriptor or file entry and indicates the location (logical block number) where subsequent information is recorded is called an allocation descriptor. The allocation descriptor includes the following long and short allocation descriptors.

<Long Allocation Descriptor>

As shown in FIG. 21, a long allocation descriptor is made up of:

extent length 410 which indicates the number of logical blocks by 4 bytes;

extent location 411 . . . which indicates the corresponding logical block number by 4 bytes;

implementation use 412 . . . information used in an arithmetic process, which is indicated by 8 bytes; and the like.

In the following description, the long allocation descriptor will be abbreviated as “LAD(logical block number)”.

<Short Allocation Descriptor>

As shown in FIG. 22, a short allocation descriptor is made up of only:

extent length 410 . . . which indicates the number of logical blocks by 4 bytes; and

extent location 411 . . . which indicates the corresponding logical block number by 4 bytes.

In the following description, the short allocation descriptor will be abbreviated as “AD(logical block number)”.

<<Unallocated Space Entry>>

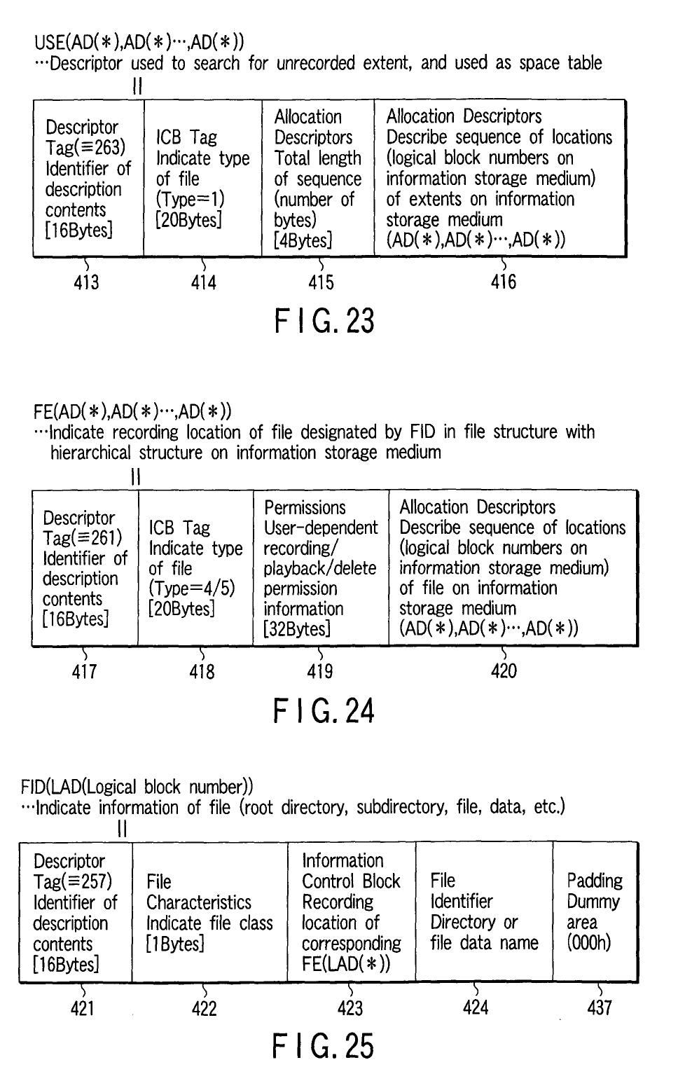

The unallocated space entry describes the “unrecorded extent distribution” on the information storage medium using short allocation descriptors for respective extents, is defined by a sequence of such short allocation descriptor, as shown in FIG. 23, and is in a space table (see FIGS. 27 to 29). As detailed contents, the unallocated space entry describes:

descriptor tag 413 . . . which indicates an identifier of the description contents (“263” in this case);

ICB tag 414 . . . which indicates file type (file type=1 in the ICB tag means an unallocated space entry, file type=4 indicates a directory, and file type=5 indicates file data); and

total length 415 of a sequence of allocation descriptors . . . which indicates the total number of bytes using 4 bytes.

<<File Entry>>

The file entry is a descriptor that has been explained in “<File system information recording contents on information storage medium>” and, as shown in FIG. 24, describes:

descriptor tag 417 . . . which indicates an identifier of the description contents (“261” in this case);

ICB tag 418 . . . which indicates a file type→the contents are the same as the aforementioned ICB tag 414;

permission 419 . . . which indicates user-dependent recording/playback/delete permission information (mainly used to assure security of files); and

allocation descriptors 420 . . . which describes a sequence of short allocation descriptors which indicate the recording locations of the corresponding file contents for respective extents.

<<File Identifier Descriptor>>

The file identifier descriptor is a descriptor that describes file information, as has been explained in “<File system information recording contents on information storage medium>” and, as shown in FIG. 25, describes:

descriptor tag 421 . . . which indicates an identifier of the description contents (“257” in this case);

file characteristics 422 . . . which indicate the file class, that means one of a parent directory, directory, file data, and file delete flag;

information control block 423 . . . which describes the FE location corresponding to this file using a long allocation descriptor;

file identifier 424 . . . directory or file name; and

padding 437 . . . a dummy area appended to adjust the total length of the file identifier descriptor, and all “0”s are normally recorded.

<<<File Structure Description Example Recorded on Information Storage Medium According to UDF>>>

The contents described in “<<Outline of UDF>>” will be explained in detail below using a practical example.

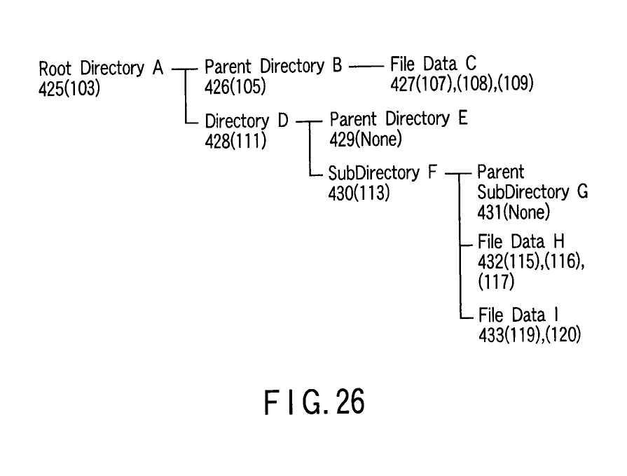

FIG. 26 shows an example of a more general file system structure compared to (a) of FIG. 20. Numerical values in parentheses indicate logical block numbers on the information storage medium where information associated with the contents of each directory or the data contents of file data are recorded.

FIGS. 27 to 29 show an example in which the information of the file system structure shown in FIG. 26 is recorded on the information storage medium according to the UDF format.

As an unrecorded location management method on the information storage medium, the following methods may be used.

Space Bitmap Method

“Recorded” or “unrecorded” flags are set in a bitmap manner for all logical blocks of a recording area in the information storage medium using a space bitmap descriptor 470.

Space Table Method

All unrecorded logical block numbers are described as a list of short allocation descriptors using a description method of an unallocated space entry 471.

This embodiment deliberately includes both the methods in FIGS. 27 to 29. However, in practice, these methods are rarely used (recorded on an information storage medium) together, and either one of these methods is used.

An outline of the contents of principal descriptors described in FIGS. 27 to 29 is as follows.

Beginning extended area descriptor 445 . . . which indicates the start position of a volume recognition sequence.

Volume structure descriptor 446 . . . which describes the explanation of the contents of a volume.

Boot descriptor 447 . . . which describes the processing contents upon booting.

Terminating extended area descriptor 448 . . . which indicates the end position of the volume recognition sequence.

Partition descriptor 450 . . . which indicates partition information (size or the like). One partition per volume is assured in a DVD-RAM in principle.

Logical volume descriptor 454 . . . which describes the contents of a logical volume.

Anchor volume descriptor pointer 458 . . . which indicates the recording locations of a main volume descriptor sequence 449 and a reserve volume descriptor sequence 467 in the recording area of the information storage medium.

Reserved (all 00h bytes) 459 to 465 . . . adjustment areas where all “0”s are recorded are allocated to assure logical sector numbers used to record specific descriptors.

Reserve volume descriptor sequence 467 . . . a backup area of information recorded in the main volume descriptor sequence 449.

<<<Access Method to File Data Upon Playback>>>

An access processing method on the information storage medium upon playing back the data contents of, e.g., file data H 432 using file system information shown in FIGS. 27 to 29 will be explained below.

1) Information of the boot descriptor 447 in the area of the volume recognition sequence 444 as a boot area upon starting up an information recording/playback apparatus or upon loading an information storage medium is reproduced. A boot process starts according to the description contents of the boot descriptor 447.

2) If no boot process is especially designated, information of the logical volume descriptor 454 in the area of the main volume descriptor sequence 449 is reproduced first.

3) The logical volume descriptor 454 describes logical volume contents use 455, which describes a logical block number indicating the recording location of a file set descriptor 472 in the long allocation descriptor format (FIG. 21). (In the example shown in FIGS. 27 to 29, the descriptor 472 is recorded in the 100th logical block since LAD(100).)

4) The 100th logical block (logical sector number=372) is accessed to reproduce the file set descriptor 472. Root directory ICB 473 in the descriptor 472 describes the recording location (logical block number) of a file entry associated with a root directory A 425 in the long allocation descriptor format (FIG. 21) (in the example shown in FIGS. 27 to 29, the descriptor 472 is recorded in the 102nd logical block since LAD(102)).

5) The 102nd logical block is accessed in accordance with LAD(102) of the root directory ICB 473 to reproduce a file entry 475 associated with the root directory A 425, thus reading the recording location (logical block number) of information associated with the contents of the root directory A 425 (AD(103)).

6) The 103rd logical block is accessed to reproduce the information associated with the contents of the root directory A 425. Since the file data H 432 is present under a tree of a directory D 428, a file identifier descriptor associated with the directory D 428 is searched for to read a logical block number (LAD(110) which is not shown in FIGS. 27 to 29) where a file entry associated with the directory D 428 is recorded.

7) The 110th logical block is accessed to reproduce a file entry 480 associated with the directory D 428, and the recording location (logical block number) of information associated with the contents of the directory D 428 is read (AD(111)).

8) The 111th logical block is accessed to reproduce the information associated with the contents of the directory D 428. Since the file data H 432 is present immediately under a subdirectory F 430, a file identifier descriptor associated with the subdirectory F 430 is searched for to read a logical block number (LAD(112) which is not shown in FIGS. 27 to 29) where a file entry associated with the subdirectory F 430 is recorded.

9) The 112th logical block is accessed to reproduce a file entry 482 associated with the subdirectory F 430, and the recording location (logical block number) where information associated with the contents of the subdirectory F 430 is recorded is read (AD113)).

10) The 113th logical block is accessed to reproduce the information associated with the contents of the subdirectory F 430, thus searching for a file identifier descriptor associated with the file data H 432. A logical block number (LAD(114) which is not shown in FIGS. 27 to 29) where a file entry associated with the file data H 432 is recorded is read from that descriptor.

11) The 114th logical block is accessed to reproduce a file entry 484 associated with the file data H 432, thus reading the recording location of data contents 489 of the file data H 432.

12) Information is reproduced from the information storage medium in the order of logical block numbers described in the file entry 484 associated with the file data H 432, thus reading the data contents 489 of the file data H 432.

<<<Specific File Data Contents Change Method>>>

A processing method including access upon changing, e.g., the data contents of the file data H 432 using the file system information shown in FIGS. 27 to 29 will be explained below.

1) The size difference between the data contents before and after the file data H 432 is changed is calculated, and that value is divided by 2048 bytes to calculate in advance the number of logical blocks to be additionally used or to be no longer required upon recording changed data.

2) Information of the boot descriptor 447 in the area of the volume recognition sequence 444 as a boot area upon starting up an information recording/playback apparatus or upon loading an information storage medium is reproduced. A boot process starts according to the description contents of the boot descriptor 447.

3) If no boot process is especially designated, a partition descriptor 450 in the area of the main volume descriptor sequence 449 is reproduced first to read information of partition contents use 451 described there. This partition contents use 451 (also called a partition header descriptor) describes the recording location of a space table or space bitmap. The space table location is described in a column of an unallocated space table 452 in the short allocation descriptor format (AD(50) in the example in FIGS. 27 to 29). Or the space bitmap location is described in a column of an unallocated space bitmap 453 in the short allocation descriptor format (AD(0) in the example of FIGS. 27 to 29).

4a) The logical block number (0) where a space bitmap is described and which is read in 3) is accessed. Space bitmap information is read from a space bitmap descriptor 470 to search for unrecorded logical blocks, thus registering use of logical blocks corresponding to the calculation result in 1) (rewrite process of information in the space bitmap descriptor 470).

4b) Or the logical block (50) which is read in 3) and where a space table is described is accessed. Unrecorded logical blocks are searched for based on USE(AD(*), AD(*), . . . , AD(*) 471 of the space table, thus registering use of logical blocks corresponding to the calculation result in 1) (rewrite process of space table information).

In a practical process one of processes “4a)” and “4b)” is executed.

5) Information of the logical volume descriptor 454 in the area of the main volume descriptor sequence 449 is reproduced.

6) The logical volume descriptor 454 describes logical volume contents use 455, which describes a logical block number indicating the recording location of the file set descriptor 472 in the long allocation descriptor format (FIG. 21). (In the example shown in FIGS. 27 to 29, the descriptor 472 is recorded in the 100th logical block since LAD(100).)

7) The 100th logical block (logical sector number=400) is accessed to reproduce the file set descriptor 472. The root directory ICB 473 in the descriptor 472 describes the recording location (logical block number) of a file entry associated with a root directory A 425 in the long allocation descriptor format (FIG. 21) (in the example shown in FIGS. 27 to 29, the descriptor 472 is recorded in the 102nd logical block since LAD(102)).

8) The 102nd logical block is accessed in accordance with LAD(102) of the root directory ICB 473 to reproduce the file entry 475 associated with the root directory A 425, thus reading the recording location (logical block number) of information associated with the contents of the root directory A 425 (AD(103)).

9) The 103rd logical block is accessed to reproduce the information associated with the contents of the root directory A 425. Since the file data H 432 is present under a tree of a directory D 428, a file identifier descriptor associated with the directory D 428 is searched for to read a logical block number (LAD(110) which is not shown in FIGS. 27 to 29) where a file entry associated with the directory D 428 is recorded.

10) The 110th logical block is accessed to reproduce the file entry 480 associated with the directory D 428, and the recording location (logical block number) of information associated with the contents of the directory D 428 is read (AD(111)).

11) The 111th logical block is accessed to reproduce the information associated with the contents of the directory D 428. Since the file data H 432 is present immediately under the subdirectory F 430, a file identifier descriptor associated with the subdirectory F 430 is searched for to read a logical block number (LAD(112) which is not shown in FIGS. 27 to 29) where a file entry associated with the subdirectory F 430 is recorded.

12) The 112th logical block is accessed to reproduce the file entry 482 associated with the subdirectory F 430, and the recording location (logical block number) where information associated with the contents of the subdirectory F 430 is recorded is read (AD113)).

13) The 113th logical block is accessed to reproduce the information associated with the contents of the subdirectory F 430, thus searching for a file identifier descriptor associated with the file data H 432. A logical block number (LAD(114) which is not shown in FIGS. 27 to 29) where a file entry associated with the file data H 432 is recorded is read from that descriptor.

14) The 114th logical block is accessed to reproduce the file entry 484 associated with the file data H 432, thus reading the recording location of the data contents 489 of the file data H 432.

15) The changed data contents 489 of the file data H 432 are recorded in consideration of the logical block numbers additionally registered in 4a) or 4b).

<<<Specific File Data/Directory Delete Processing Method>>>

For example, a method of deleting the file data H 432 or subdirectory F 430 will be explained below.

1) Information of the boot descriptor 447 in the area of the volume recognition sequence 444 as a boot area upon starting up an information recording/playback apparatus or upon loading an information storage medium is reproduced. A boot process starts according to the description contents of the boot descriptor 447.

2) If no boot process is especially designated, a partition descriptor 450 in the area of the main volume descriptor sequence 449 is reproduced first.

3) The logical volume descriptor 454 describes logical volume contents use 455, which describes a logical block number indicating the recording location of the file set descriptor 472 in the long allocation descriptor format (FIG. 21). (In the example shown in FIGS. 27 to 29, the descriptor 472 is recorded in the 100th logical block since LAD(100).)

4) The 100th logical block (logical sector number=400) is accessed to reproduce the file set descriptor 472. The root directory ICB 473 in the descriptor 472 describes the recording location (logical block number) of a file entry associated with a root directory A 425 in the long allocation descriptor format (FIG. 21) (in the example shown in FIGS. 27 to 29, the descriptor 472 is recorded in the 102nd logical block since LAD(102)).

5) The 102nd logical block is accessed in accordance with LAD(102) of the root directory ICB 473 to reproduce the file entry 475 associated with the root directory A 425, thus reading the recording location (logical block number) of information associated with the contents of the root directory A 425 (AD(103)).

6) The 103rd logical block is accessed to reproduce the information associated with the contents of the root directory A 425. Since the file data H 432 is present under a tree of a directory D 428, a file identifier descriptor associated with the directory D 428 is searched for to read a logical block number (LAD(110) which is not shown in FIGS. 27 to 29) where a file entry associated with the directory D 428 is recorded.

7) The 110th logical block is accessed to reproduce the file entry 480 associated with the directory D 428, and the recording location (logical block number) of information associated with the contents of the directory D 428 is read (AD(111)).

8) The 111th logical block is accessed to reproduce the information associated with the contents of the directory D 428. Since the file data H 432 is present immediately under the subdirectory F 430, a file identifier descriptor associated with the subdirectory F 430 is searched for.

In order to delete the subdirectory F430, a “file delete flag” is set in the file characteristics 422 (FIG. 25) in the file identifier descriptor associated with the subdirectory F 430. A logical block number (LAD(112) which is not shown in FIGS. 27 to 29) where a file entry associated with the subdirectory F 430 is recorded is read.

9) The 112th logical block is accessed to reproduce the file entry 482 associated with the subdirectory F 430, and the recording location (logical block number) where information associated with the contents of the subdirectory F 430 is recorded is read (AD113)).

10) The 113th logical block is accessed to reproduce the information associated with the contents of the subdirectory F 430, thus searching for a file identifier descriptor associated with the file data H 432.

In order to delete the file data H 432, a “file delete flag” is set in the file characteristics 422 (FIG. 25) in the file identifier descriptor associated with the file data H 432. Furthermore, a logical block number (LAD(114) which is not shown in FIGS. 27 to 29) where a file entry associated with the file data H 432 is recorded is read from that descriptor.

11) The 114th logical block is accessed to reproduce the file entry 484 associated with the file data H 432, thus reading the recording location of the data contents 489 of the file data H 432.

Upon deleting the file data H 432, a logical block where the data contents 489 of the file data H 432 are recorded is released by the following methods (that logical block is registered in an unrecorded state).

12) The partition descriptor 450 in the area of the main volume descriptor sequence 449 is reproduced to read information of the partition contents use 451 described in that descriptor. This partition contents use 451 (also called a partition header descriptor) describes the recording location of a space table or space bitmap.

The space table location is described in a column of an unallocated space table 452 in the short allocation descriptor format (AD(50) in the example in FIGS. 27 to 29). Or the space bitmap location is described in a column of an unallocated space bitmap 453 in the short allocation descriptor format (AD(0) in the example of FIGS. 27 to 29).

13a) The logical block number (0) where a space bitmap is described and which is read in 12) is accessed to rewrite the “logical block number to be released” obtained as a result of 11) in the space bitmap descriptor 470.

13b) Or the logical block (50) which is read in 12) and where a space table is described is accessed to rewrite the “logical block number to be released” obtained as a result of 11) in the space table.

In a practical process one of processes “13a)” and “13b)” is executed.

Upon deleting the file data H 432, 12) the recording location of data contents 490 of file data I 433 is read by executing the same sequence in 10) and 11).

14) The partition descriptor 450 in the area of the main volume descriptor sequence 449 is reproduced to read information of the partition contents use 451 described in that descriptor. This partition contents use 451 (also called a partition header descriptor) describes the recording location of a space table or space bitmap.

The space table location is described in a column of an unallocated space table 452 in the short allocation descriptor format (AD(50) in the example in FIGS. 27 to 29). Or the space bitmap location is described in a column of an unallocated space bitmap 453 in the short allocation descriptor format (AD(0) in the example of FIGS. 27 to 29).

15a) The logical block number (0) where a space bitmap is described and which is read in 13a) is accessed to rewrite the “logical block number to be released” obtained as a result of 11) and 12) in the space bitmap descriptor 470.

15b) Or the logical block (50) which is read in 13b) and where a space table is described is accessed to rewrite the “logical block number to be released” obtained as a result of 11) and 12) in the space table.

In a practical process one of processes “15a)” and “15b)” is executed.

<<<File Data/Directory Add Process>>>

For example, an access/add process method upon adding new file data or a directory under the subdirectory F 430 will be described below.

1) Upon adding file data, the size of the file data contents to be added is checked, and that value is divided by 2048 bytes to calculate in advance the number of logical blocks required to add file data.

2) Information of the boot descriptor 447 in the area of the volume recognition sequence 444 as a boot area upon starting up an information recording/playback apparatus or upon loading an information storage medium is reproduced. A boot process starts according to the description contents of the boot descriptor 447.

3) If no boot process is especially designated, a partition descriptor 450 in the area of the main volume descriptor sequence 449 is reproduced first to read information of partition contents use 451 described there. This partition contents use 451 (also called a partition header descriptor) describes the recording location of a space table or space bitmap.

The space table location is described in a column of an unallocated space table 452 in the short allocation descriptor format (AD(50) in the example in FIGS. 27 to 29). Or the space bitmap location is described in a column of an unallocated space bitmap 453 in the short allocation descriptor format (AD(0) in the example of FIGS. 27 to 29).

4a) The logical block number (0) where a space bitmap is described and which is read in 3) is accessed. Space bitmap information is read from the space bitmap descriptor 470 to search for unrecorded logical blocks, thus registering use of logical blocks corresponding to the calculation result in 1) (rewrite process of information in the space bitmap descriptor 470).

4b) Or the logical block (50) which is read in 3) and where a space table is described is accessed. Unrecorded logical blocks are searched for based on USE(AD(*), AD(*), . . . , AD(*) 471 of the space table, thus registering use of logical blocks corresponding to the calculation result in 1) (rewrite process of space table information).

In a practical process one of processes “4a)” and “4b)” is executed.

5) Information of the logical volume descriptor 454 in the area of the main volume descriptor sequence 449 is reproduced.

6) The logical volume descriptor 454 describes logical volume contents use 455, which describes a logical block number indicating the recording location of the file set descriptor 472 in the long allocation descriptor format (FIG. 21). (In the example shown in FIGS. 27 to 29, the descriptor 472 is recorded in the 100th logical block since LAD(100).)

7) The 100th logical block (logical sector number=400) is accessed to reproduce the file set descriptor 472. The root directory ICB 473 in the descriptor 472 describes the recording location (logical block number) of a file entry associated with a root directory A 425 in the long allocation descriptor format (FIG. 21) (in the example shown in FIGS. 27 to 29, the descriptor 472 is recorded in the 102nd logical block since LAD(102)).

8) The 102nd logical block is accessed in accordance with LAD(102) of the root directory ICB 473 to reproduce the file entry 475 associated with the root directory A 425, thus reading the recording location (logical block number) of information associated with the contents of the root directory A 425 (AD(103)).

9) The 103rd logical block is accessed to reproduce the information associated with the contents of the root directory A 425.

A file identifier descriptor associated with the directory D 428 is searched for to read a logical block number (LAD(110) which is not shown in FIGS. 27 to 29) where a file entry associated with the directory D 428 is recorded.

10) The 110th logical block is accessed to reproduce the file entry 480 associated with the directory D 428, and the recording location (logical block number) of information associated with the contents of the directory D 428 is read (AD(111)).

11) The 111th logical block is accessed to reproduce the information associated with the contents of the directory D 428.

A file identifier descriptor associated with the subdirectory F 430 is searched for to read a logical block number (LAD(112) which is not shown in FIGS. 27 to 29) where a file entry associated with the subdirectory F 430 is recorded.

12) The 112th logical block is accessed to reproduce the file entry 482 associated with the subdirectory F 430, and the recording location (logical block number) where information associated with the contents of the subdirectory F 430 is recorded is read (AD113)).

13) The 113th logical block is accessed to register a file identifier descriptor of new file data or directory to be added in the information associated with the contents of the subdirectory F 430.

14) The logical block number position registered in 4a) or 4b) is accessed to register a file entry associated with the new file data or directory to be added.

15) The logical block position indicated by a short allocation descriptor in the file entry in 14) is accessed to record a file identifier descriptor of a parent directory associated with the directory to be added or the data contents of the file data to be added.

Subsequently, the continuity and CDA of video information upon recording will be additionally explained. The continuity and CDA of video information upon recording are described in Jpn. Pat. Appln KOKAI Publication No. 2000-112673.

Unlike conventional computer information, the continuity of video information upon recording must be guaranteed as an indispensable condition. A reason for disturbing the continuity upon recording, and a method of guaranteeing the continuity upon recording will be described below.

Video information sent from an external device is temporarily saved in a buffer memory (semiconductor memory). When an optical head has reached a recording position on an information storage medium via coarse and fine access processes, the video information temporarily saved in the buffer memory is recorded on the information storage medium via the optical head. The transmission rate of the video information sent from the buffer memory to the optical head is defined as a physical transmission rate (PTR). The transmission rate of video information transmitted from an external device to the buffer memory is defined as a system transmission rate (STR). In general, the physical transmission rate PTR and system transmission rate STR have different values.

In order to sequentially record video information at different locations on the information storage medium, an access operation that moves the focused spot position of the optical head is required. To attain large movement, coarse access for moving the entire optical head is made, and to attain movement for a small distance, fine access for moving only an objective lens used to focus a laser beam is made.

Transition in size of the video information to be temporarily saved in the buffer memory along with an elapse of time when video information is to be sequentially recorded at a predetermined position on the information storage medium while executing access control of the optical head in correspondence with video information transmitted from an external device will be described below. In general, since the physical transmission rate PTR is higher than the system transmission rate STR, the size of the video information to be temporarily saved in the buffer memory is decreasing during the video information recording time period. The size of the video information to be temporarily saved in the buffer memory then becomes “0”. At this time, video information which is continuously transmitted from the external device is continuously recorded on the information storage medium without being temporarily saved in the buffer memory, and the size of the video information to be temporarily saved in the buffer memory undergoes a transition while it is “0”.

When video information is to be subsequently recorded at another position on the information storage medium, an access process of the optical head is executed prior to the recording operation. As an access period of the optical head, three different times, i.e., a coarse access time, fine access time, and rotation wait time of the information storage medium, are required. Since no recording process on the information storage medium is made during period, the physical transmission rate PTR during this period becomes substantially “0”. By contrast, since the average system transmission rate STR of video information sent from the external device to the buffer memory remains unchanged, the temporarily saved size of the video information in the buffer memory is increasing.

Upon completion of access of the optical head, when the recording process on the information storage medium is restarted (video information recording time period), the temporarily saved size of the video information in the buffer memory decreases again. This decrease slope is determined by:

(average system transmission rate STR)−(physical transmission rate PTR)

After that, when a position near the recording position on the information recording medium is to be accessed, only fine access is required. Hence, only the fine access time and rotation wait time are required.

In this way, a condition that allows continuous recording can be specified by the “upper limit value of the access count within a specific period”. Continuous recording has been exemplified, and a condition that allows continuous playback can also be specified by the “upper limit value of the access count within a specific period” for a similar reason to the aforementioned contents.

An access count condition that makes continuous recording absolutely impossible will be explained below. When the access frequency is highest, the video information recording time is very short, and only the fine access time and rotation wait time are successively required. In such case, it is impossible to assure recording continuity independently of the physical transmission rate PTR. If BM represents the size of the buffer memory, the buffer memory becomes full of temporarily saved video information within a period given by BM÷STR, and it becomes impossible to temporarily save new incoming video information. As a result, video information that cannot be temporarily saved in the buffer memory cannot be continuously recorded.

When the video information recording time and access time are well-balanced, and the temporarily saved video information size in the buffer memory is nearly globally constant, the continuity of video information recording viewed from an external system can be assured without overflowing the temporarily saved video information in the buffer memory. Let SATi be each coarse access time (seek access time of the objective lens), JATi be each fine access time, SATa be the average access time after n accesses, JATa be the average fine access time, DWTi (data write time) be the video information recording time of each access, and DWTa be the average video information recording time upon recording video information on an information storage medium after each access, which is calculated as the average value after n accesses. Also, let MWTi (spindle motor wait time) be the rotation wait time per access, and MWTa be the average rotation wait time after n accesses.

Then, a video information data size transmitted from an external device to the buffer memory during a total access period upon making n accesses is given by:

STR×(Σ(SATi+JATi+MWTi))STR×n×(SATa+JATa+MWTa) (1)

Also, a video information size transmitted from the buffer memory to the information storage medium upon recording video information after n accesses is given by:

(PTR−STR)×ΣDWTi(PTR−STR)×n·DWTa (2)

If

(PTR−STR)×n·DWTa≧STR×n×(SATa+JATa+MWTa)

That is, (PTR−STR)×DWTa≧STR×(SATa+JATa+MWTa) (3)

holds between formulas (1) and (2), continuity upon recording video information viewed from an external system is assured.

If Ta represents the average time required per access, it is given by:

Ta=SATa+JATa+MWTa (4)

Hence, relation (3) becomes:

(PTR−STR)×DWTa≧STR×Ta (5)

By limiting the lower limit value of the data size to be continuously recorded after each access, the average access count is decreased. The aforementioned CDA corresponds to a data area on the information storage medium that is to undergo continuous recording after each access. Relation (5) can be modified to:

DWTa≧STR×Ta/(PTR−STR) (6)

CDAS that indicates the CDA size is obtained by:

CDAS=DWTa×PTR (7)

Hence, from relation (6) and equation (7), we have:

CDAS≧STR×PTR×Ta/(PTR−STR) (8)

The lower limit value of the CDA size that allows continuous recording can be specified based on relation (8).

The times required for coarse access and fine access largely vary depending on the performance of an information recording/playback apparatus. The coarse access time is assumed to be:

SATa 200 ms (9)

As described above, for example, MWTa=18 ms, and JATa=5 ms are used in calculations.

A 2.6 GB DVD-RAM has a physical transmission rate PTR of:

PTR=11.08 Mbps (10)

If the average transmission rate of MPEG2 is:

STR 4 Mbps (11)

substitution of the aforementioned numerical value in relation (8) yields:

CDAS≧1.4 Mbits (12)

As another estimation, if

SATa+JATa+MWTa=1.5 seconds (13)

relation (8) yields:

CDAS≧9.4 Mbits (14)

Since the recording/playback DVD standard specifies the maximum transmission rate of MPEG2 to be equal to or lower than:

STR=8 Mbps (15)

substitution of the value of equation (15) into relation (8) yields:

CDAS≧43.2 Mbits=5.4 MBytes (16)

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information storage medium comprising:
a logical space managed by a first file system, and
the logical space having a space that stores a file used to designate a space area of a second file system, which is different from the first file system.

2. An information recording method for recording information on an information storage medium having a logical space managed by a first file system, comprising:
recording in the logical space a file used to designate a space area of a second file system, which is different from the first file system.
